(19) United States
(12) Patent Application Publication
(10) Pub. No.: US 2006/0091595 A1
(43) Pub. Date: May 4, 2006

(54) Stabilizer bushing

(75) Inventors: Yukio Hayashi, Kasugai-shi (JP); Koichi Kobayashi, Kasugai-shi (JP)

Correspondence Address: OLIFF & BERRIDGE, PLC, P.O. BOX 19928, ALEXANDRIA, VA, 22320, US

(73) Assignee: TOKAI RUBBER INDUSTRIES, LTD., Komaki-shi (JP)

(21) Appl. No.: 11/251,938

(22) Filed: Oct. 18, 2005

(30) Foreign Application Priority Data
Oct. 29, 2004 (JP) 2004-316866

(51) Int. Cl. B60G 11/18

(52) U.S. Cl. 267/276

(57) ABSTRACT

A stabilizer bushing including a rubber elastic body; a bracket and a medial plate embedded in a medial portion of the rubber elastic body in an axis-perpendicular direction so as to extend over substantially an entire axial length of the rubber elastic body so that the rubber elastic body is divided by the medial plate into an inner rubber layer and an outer rubber layer having a smaller spring constant than the inner rubber layer. The stabilizer bushing is composed of two circumferential segmented parts wherein the bracket and medial plate are integrally vulcanization bonded to the segmented parts, which segmented parts are assembled together sandwiching a stabilizer bar in the axis-perpendicular direction and subjected to compression in the axis-perpendicular direction so that an inside face of an through-hole is subjected to bonding to the outer circumferential surface of a stabilizer bar with an adhesive.

### INCORPORATED BY REFERENCE

The disclosure of Japanese Patent Application No. 2004-316866 filed on Oct. 29, 2004 including the specification, drawings and abstract is incorporated herein by reference in its entirety.

### BACKGROUND OF THE INVENTION

1. Field of the Invention

This invention relates to a stabilizer bushing for elastically supporting a stabilizer bar on a body of an automotive vehicle.

2. Description of the Related Art

A stabilizer bar is a torsionally rigid spring (torsion bar) attached to the vehicle body in order to reduce tilting. The stabilizer bar is installed with the ends thereof mounted on the left and right suspension, and acts to suppress different vertical movements by the left and right wheels. For example, when turning a corner, when due to centrifugal force the outside suspension becomes compressed and the inside suspension becomes extended, as a result of which the body tends to tilt towards the outside due to the centrifugal force. When the left and right wheel move vertically in opposite phase (i.e. during rolling), the stabilizer bar will undergo twisting, whereupon opposite phase motion of the left and right wheels is suppressed by means of the resistance provided by torsional rigidity, while the left and right wheels which have undergone opposite phase motion are quickly restored to the original state by the elastic recovery force accumulated through twisting.

As explained above, the stabilizer bar has the function of reducing roll angle, thereby increasing the drive stability of the vehicle body. When mounting the stabilizer bar onto the body, stabilizer bushings are interposed between the body and the stabilizer bar to function as of vibration insulating components, so that the stabilizer bar is elastically supported on the body.

FIG. 6 depicts an example of a stabilizer bar is elastically supported on a vehicle body, using stabilizer bushings (disclosed in JP-A-2001-271860). A stabilizer bar 200 is composed of a metal rod, and has a generally a gate shaped overall in plan view. The stabilizer bar 200 includes a central section 200A, which is substantially linear in the vehicle width direction (lateral direction of the vehicle body), affixed to a vehicle body 204 via a pair of stabilizer bushings 202, and arm sections 200B extending from both ends of the central section 200A. The arm sections 200B are affixed at their end portions to suspension arms 208 that support both wheels 206.

The stabilizer bushing 202 has a rubber elastic body 210 with a through-hole 216. With the stabilizer bar 200 passed through the through-hole 216, the rubber elastic body 210 is affixed to the vehicle body 204 by means of a bracket 214 having an outer tube portion 212, while fitting within the recess 220 on the inner side of the outer tube portion 212.

FIG. 7 depicts an example of a conventional stabilizer bushing. As shown in the drawing, in conventional practice, the rubber elastic body 210 is vulcanization molded as a separate element from the bracket 214. A partition 218 extending up to the through-hole 216 is then made in the rubber elastic body 210, and with the rubber elastic body 210 fitted onto the stabilizer bar 200 through the partition 218. Namely, with the stabilizer bar 200 passing through the through-hole 216, the rubber elastic body 210 is affixed to the vehicle body 204 by means of the bracket 214.

The bracket 214 has on the inner side of the outer tube portion 212a recess 220 into which the rubber elastic body 210 fits internally, and at the two ends thereof has fastening portions 222 of plate form, allowing it to be affixed to the vehicle body 204 at the fastening portions 222.

A problem with this kind of stabilizer bushing 202 is that, due to input of twist or the like to the stabilizer bar 200, the inside face of the through-hole 216 can experience slippage relative to the stabilizer bar 200, and this slippage can produce abnormal noise, such as stick-slip noise.

To address this problem, JP-A-2002-248923 discloses one countermeasure, i.e. during vulcanization molding of the rubber elastic body 210, to integrally vulcanization bond the part to the stabilizer bar 200. However, this requires that vulcanization molding of the rubber elastic body 210 be carried out with the large, unwieldy stabilizer bar 200 set directly in the mold for the rubber elastic body 120, resulting in the problem of significant equipment costs entailed by large scale equipment.

On the other hand, it has also been proposed to vulcanization mold the rubber elastic body 210 individually, and to then bond the inside face of the through-hole 216 to the stabilizer bar 200 by a post-bonding process. This is taught, for example, in JP-A-11-108096 and JP-A-2001-270315.

However, where the rubber elastic body 210 is formed individually by vulcanization molding, and then bonded to the stabilizer bar 200 by an post-bonding process, it is necessary for the bonding face of the rubber elastic body 120, i.e. the inside face of the through-hole 216, to be bonded to the outside face of the stabilizer bar 200 while having been placed in sufficient intimate contact therewith. Accordingly, it is desirable to carry out the post-bonding process while subjecting the rubber elastic body 210 fitted onto the stabilizer bar 200 to applied pressure from the outside so as to induce compressive deformation of the rubber elastic body 210 in the diameter constricting direction.

FIGS. 8A-8C depict one means for doing the post-bonding. An adhesive S is applied to the outside circumferential surface of the stabilizer bar 200 over a predetermined axial length thereof. The rubber elastic body 210 is fitted thereon. The rubber elastic body 210 is then subjected to pressure in the axis-perpendicular direction by means of a pressure jig 224, to induce compressive deformation of the rubber elastic body 210. In this state, the assembly is held in a heated oven for a predetermined time period, to effect the post-bonding process of the rubber elastic body 210 and the stabilizer bar 200 with the adhesive S. The bracket 214 discussed above could be used instead of the pressure jig 224.

As shown in FIG. 8C, when the rubber elastic body 210 fitted onto the stabilizer bar 200 is subjected to applied pressure from the outside thereof in the axis-perpendicular direction and caused thereby to undergo compressive deformation in the same direction, the rubber elastic body 210, and particularly the portion thereof on the inner peripheral side, i.e. the portion around the through-hole 216, undergoes appreciable deformation in the axial direction in association with slipping of the inside face of the through-hole 216 in the axial direction with respect to the stabilizer bar 200.

As a result, appreciable necking K is produced at the two axial end portions and at the inner peripheral portion of the rubber elastic body 210, and the adhesive S which has been applied to the stabilizer bar 200 is caused to flow in the axial direction in association with deformation of the rubber, creating the risk of insufficient bonding force or uneven bonding. Where such insufficient bonding force or uneven bonding has occurred, a high level of stress operates at the adhesive interface of the rubber elastic body 210 and the stabilizer bar 200, tending to create stress concentrations there. In particular, as the two axial ends of the adhesive face constitute the terminus of the necking K, particularly large stress concentrations are produced in these areas, which can then function as starting points for the occurrence and axial propagation of adhesive separation between the rubber elastic body 210 and the stabilizer bar 200 during service, creating the risk of causing a reduction in endurance life. Another problem is that muddy water can infiltrate into the necking K during service.

In the case where the rubber elastic body 210 and the stabilizer bar 200 are bonded in this way, it is possible to prevent slippage at that location. However, slippage tends instead to be produced at the contact interface of the rubber outer circumferential surface of the elastic body 210 and the bracket 214, due to input of twisting or the like applied to the stabilizer bar 200, and this slippage can produce abnormal noise, such as stick-slip noise.

### SUMMARY OF THE INVENTION

It is therefore one object of this invention to provide a stabilizer bushing that does not give rise to slippage which produces unpleasant stick-slip noise or other such abnormal noise at the contact interface of the rubber elastic body and the bracket; that affords good bond strength and bond reliability for excellent endurance life; and that can be manufactured cheaply.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

A first mode of the present invention provides a stabilizer bushing for elastically supporting a stabilizer bar on a vehicle body, comprising: a tubular rubber elastic body with a through-hole; a rigid bracket provided with a recess into which the rubber elastic body fits internally, the stabilizer bar being passed through the through hole, and the rubber elastic body being affixed to the vehicle body by the bracket so that the stabilizer bar is elastically supported on the vehicle body; and a rigid circumferential medial plate embedded in a medial portion of the rubber elastic body in an axis-perpendicular direction so as to extend over substantially an entire axial length of the rubber elastic body with a transverse cross sectional shape curving around the through-hole so that the rubber elastic body is divided by the medial plate into an inner rubber layer situated on an inner peripheral side and an outer rubber layer situated on an outer peripheral side and having a smaller spring constant than the inner rubber layer, wherein the rubber elastic body, the bracket, and the medial plate are segmented into at least two circumferential segmented parts at a segmentation plane passing through the through-hole, and the bracket and medial plate are integrally vulcanization bonded to the segmented parts during vulcanization molding of the rubber elastic body, and wherein the integrally vulcanized segmented parts are assembled together sandwiching the stabilizer bar in an axis-perpendicular direction and subjected to compression in the axis-perpendicular direction so that an inside face of the through-hole is subjected to post-bonding to an outer circumferential surface of the stabilizer bar with an adhesive.

A second mode of the present invention provides a stabilizer bushing according to the aforementioned first mode, wherein the inner rubber layer is thinner than the outer rubber layer.

A third mode of the present invention provides a stabilizer bushing according to the aforementioned first and second mode, wherein the outer rubber layer has shorter axial length than the inner rubber layer.

A fourth mode of the present invention provides a stabilizer bushing according to any one of the first through third modes, wherein the bracket has holes for fastening to the vehicle body provided in each of the segmented parts at locations to either side of the rubber elastic body in the axis-perpendicular direction.

A fifth mode of the present invention provides a stabilizer bushing according to any one of the first through fourth modes, wherein with the segmented parts being assembled together, a radially inner most part of the inner rubber layer of the rubber elastic body, which constitute the inside face of the through-hole, extends continuously over an entire circumference of the outer circumferential surface of the stabilizer bar via the adhesive, and radially medial and outer parts of the inner rubber layer has circumferential gaps each having a circumferential length gradually increases as it extends radially outwardly, between circumferentially opposite faces of the segmented parts.

According to the present invention as set forth above, a rigid medial plate is embedded in the medial portion of the axis-perpendicular cross section of the tubular rubber elastic body with respect to the stabilizer bar. Therefore, the stabilizer bushing including the rubber elastic body, medial plate, and a rigid bracket is segmented along a segmentation plane that passes through the through-hole, with the rubber elastic body, medial plate, with rigid bracket of each of the segmented parts being integrally vulcanization bonded, while the inside face of the through-hole is subjected to post-bonding to the outer circumferential surface of the stabilizer bar, with the segmented parts compressed while sandwiching the stabilizer. In the present invention, since the spring constant of the outer rubber layer on the outer peripheral side is smaller than that of the inner rubber layer to the inside of the medial plate in the rubber elastic body, when the stabilizer bar is compressed while sandwiched by the segmented parts in the axis-perpendicular direction, deformation of the inner rubber layer in the axial direction may be held to a minimum, so that flow of the adhesive in the axial direction in association with excessive deformation of the inner rubber layer can be reduced satisfactorily and appreciable necking at the axial ends of the interface of the inner rubber layer and the stabilizer bar can be prevented. As a result, concentration of stress at the adhesive interface, especially at the two axial ends of the adhesive interface constituting the necking terminus, can be effectively reduced, and adhesive separation due to the occurrence of cracking in these sections and subsequent propagation of cracks along the adhesive interface, can be effectively prevented.

Meanwhile, by means of the medial plate embedded in the medial portion of its cross section, pressure applied to the rubber elastic body in the diameter constricting direction is distributed uniformly over the adhesive interface of the rubber elastic body, specifically the inner face of the through-hole of the inner rubber layer, over the entire axial length thereof, as a result of which high adhesive force between the rubber elastic body and the stabilizer bar is achieved. Additionally, when twisting input is applied to the stabilizer bar during service of the stabilizer bar, it is the outer rubber layer that principally undergoes large deformation, with deformation of the inner rubber layer being minimal, thus reducing the load on the inner rubber layer and holding down concentration of stress in the inner rubber layer, specifically the inner face of the through-hole (adhesive interface), whereby the effects of improved endurance of the stabilizer bushing and enhanced adhesive reliability may be achieved.

Additionally, as mentioned above, since appreciable necking does not occur between the stabilizer bar and the stabilizer bushing, specifically the inner rubber layer, the problem of infiltration of muddy water into the area is resolved.

Since it is possible to vary the spring constant of the outer rubber layer while assuring that sufficient adhesive force against the stabilizer bar is maintained on the inner rubber layer side, there is the additional advantage of a wider tuning range for the overall spring constant. Further, in the present invention, since the bracket for fastening the rubber elastic body to the vehicle body is vulcanization bonded to the rubber elastic body, the problem of slippage between the rubber elastic body and the bracket and abnormal noise produced thereby can be prevented concomitantly. Additionally, since the present invention teaches post-bonding the stabilizer bushing to the stabilizer bar after vulcanization molding, production costs are lower than where the components are integrally vulcanization bonded during vulcanization molding.

The inner rubber layer may be made thinner than the outer rubber layer (Second Mode). With this arrangement, the outer rubber layer can effectively be imparted with lower spring constant with respect to the inner rubber layer.

The outer rubber layer can also be given shorter axial length than the inner rubber layer (Third Mode). With this arrangement, the outer rubber layer can effectively be imparted with relatively lower spring constant with respect to the inner rubber layer.

The fourth mode teaches providing the bracket in each of the segmented parts with holes for fastening to the vehicle body, at locations to either side of the rubber elastic body in the axis-perpendicular direction. With this arrangement, by means of fastening the brackets of the segmented parts by means of bolts or other fastener components placed in the fastening holes, it becomes a simple matter to subject the rubber elastic body to the post-bonding process in a high temperature oven while held compressed in the diameter constricting direction.

The fifth mode teaches providing the gaps between circumferential opposite surfaces of the segmented parts at radially medial and outer portions of the inner rubber layer, while the radially inner most part of the inner rubber layer extends continuously over the entire circumference of the outer circumferential surface of the stabilizer bar via the adhesive. With this arrangement, when the inner rubber layer is subjected to compression in the axis-perpendicular direction, elastic deformation of the inner rubber layer is effectively absorbed by this gap, thereby compression force is effectively exerted on a sealing face of the inner rubber layer, i.e. the inner most part of the inner rubber layer continuously extending over the entire circumference of the stabilizer bar via the adhesive, ensuring enhanced bonding stability between the inner rubber layer and the stabilizer bar.

### BRIEF DESCRIPTION OF THE DRAWINGS

The forgoing and/or other objects features and advantages of the invention will become more apparent from the following description of a preferred embodiment with reference to the accompanying drawings in which like reference numerals designate like elements and wherein:

FIGS. 1A and 1B show stabilizer bushings of construction according to one preferred form of the present invention, which are attached to a stabilizer bar of an automotive vehicle at respective positions;

FIG. 2 is a cross sectional view taken along line 2-2 of FIG. 1A;

FIG. 3 is an axial cross sectional view of one of the stabilizer bushing shown in FIGS. 1A and 1B;

FIG. 4 is an exploded view showing segmented parts of the stabilizer bushing of FIG. 2 in a separate state;

FIGS. 5A and 5B show assembling steps of the stabilizer bushings of FIGS. 1A and 1B;

FIG. 6 shows conventional stabilizer bushing attached to a vehicle stabilizer bar;

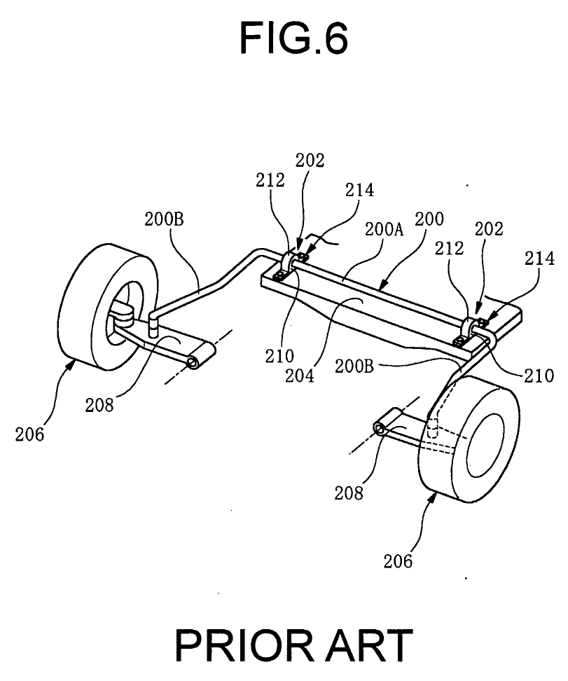

FIG. 7 is an exploded view showing components of the conventional stabilizer bushing of FIG. 6; and

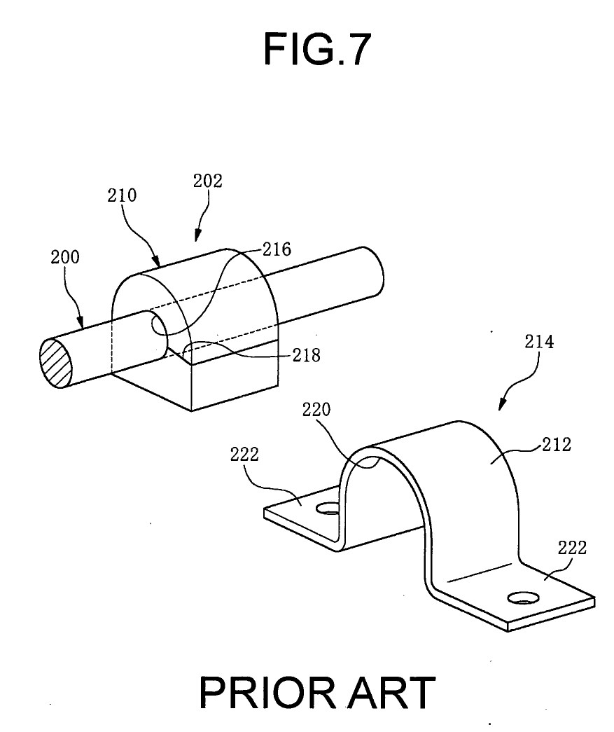

FIGS. 8A-8C show conventional assembling steps for post-bonding the conventional stabilizer bushing to the stabilizer bar.

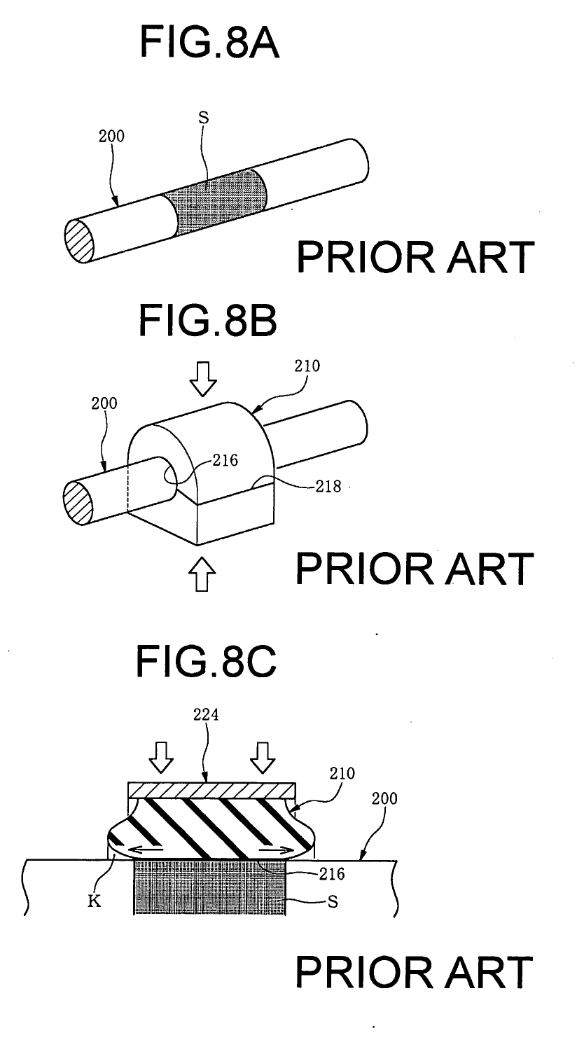

### DETAILED DESCRIPTION OF PREFERRED EMBODIMENTS

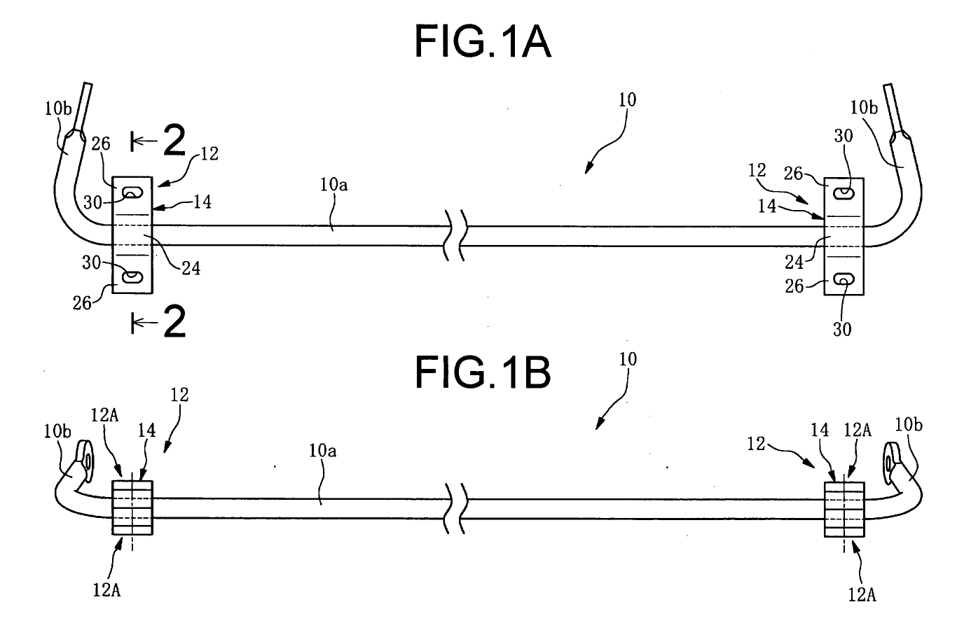

Referring first to FIGS. 1A and 1B, shown is a stabilizer bar 10 consisting of a metal rod, having a planar configuration overall that is generally a gate shaped, with its central section 10a. Namely, the stabilizer bar 10 is substantially linear in the vehicle width direction (lateral direction of the vehicle body), and is affixed to the vehicle body by stabilizer bushings 12 with arm sections 10b at its two ends affixed at their end portions to suspension arms that support wheels.

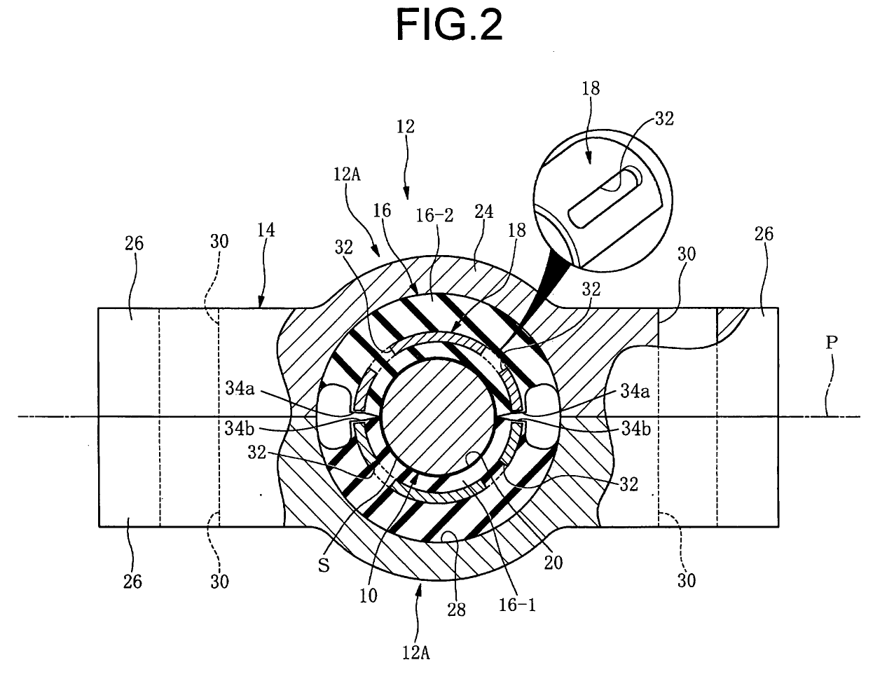

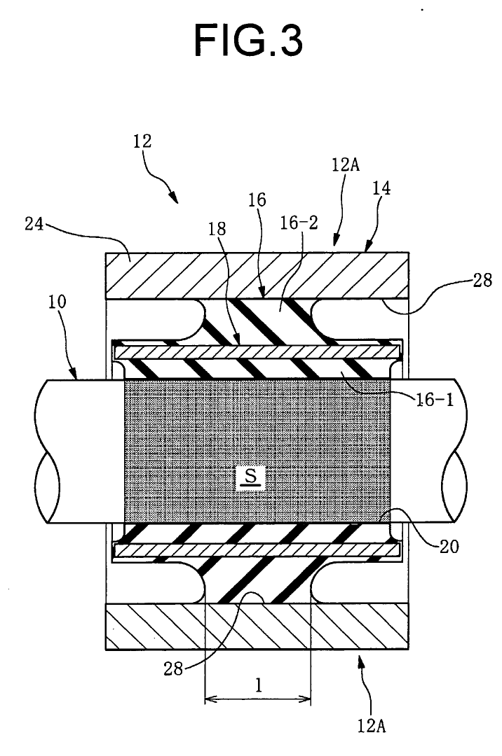

In FIG. 2 and FIG. 3, the specific arrangement of the stabilizer bushing 12 while attached to the stabilizer bar 10 is depicted in detail, together with the stabilizer bar 10 itself. As will be apparent from the drawings, the stabilizer bushing 12 of the embodiment has a rigid bracket 14 made of metal, a rubber elastic body 16, and a rigid medial plate 18 made of metal, embedded within the rubber elastic body 16.

The rubber elastic body 16 is of tubular shape in transverse cross section, and has a circular through-hole 20 in the center, through which the stabilizer bar 10 is passed. The inner face of the through-hole 20 and the outer circumferential surface of the stabilizer bar 10 are bonded together with an adhesive S. Here, a chlorinated rubber adhesive can be used favorably as the adhesive S.

The medial plate 18 and the rubber elastic body 16 are integrally vulcanization bonded to one another during vulcanization molding of the rubber elastic body 16. As depicted in FIG. 2, the bracket 14 has an outer tubular portion 24 for enveloping the rubber elastic body 16, and a pair of fastening portions 26 that extend to left and right therefrom in the drawing, i.e. fastening portions 26 situated to either side of the rubber elastic body 16 in the axis-perpendicular direction. Each fastening portion 26 is perforated by a fastening hole 30, so that the fastening portion 26 may be fastened to the vehicle body at the fastening holes 30.

The outer tubular portion 24 has a circular recess 28 corresponding in shape to the outer circumferential surface of the rubber elastic body 16, into which the rubber elastic body 16 fits internally. In the assembled state depicted in FIG. 2 and FIG. 3, the rubber elastic body 16 is subjected to applied force in the diameter constricting direction from its outside circumferential surface, and undergoes overall compressive deformation in the diameter constricting direction.

The bracket 14 and the rubber elastic body 16 are integrally vulcanization bonded to one another during vulcanization molding of the rubber elastic body 16. The aforementioned medial plate 18 has a cross sectional shape that curves around the through-hole 20, here, specifically, a cross sectional shape that encircles the through-hole 20, and is embedded in the medial portion of the axis-perpendicular cross section of the rubber elastic body 16 with respect to the stabilizer bar 10. By means of this, the rubber elastic body 16 is divided by the medial plate 18 into an inner rubber layer 16-1 situated on the inner peripheral side, and an outer rubber layer 16-2 situated on the outer peripheral side, as depicted in FIG. 3

The inner rubber layer 16-1 and the outer rubber layer 16-2 are integrally formed of the same rubber material, with the inner rubber layer 16-1 being thinner than the outer rubber layer 16-2. In this way, a location close to the through-hole 20 is selected as the location for embedding the medial plate 18. The medial plate 18 has length substantially coextensive with the entire axial length of the rubber elastic body 16. That is, the medial plate 18 is embedded in the rubber elastic body 16 over substantially the entire length of the rubber elastic body 16.

As clearly shown in FIG. 3, the axial length 1 of the outer rubber layer 16-2 is shorter than the axial length of the inner rubber layer 16-1. As a result, in the rubber elastic body 16, the inner rubber layer 16-1 has a large spring constant, while the outer rubber layer 16-2 has a small spring constant. Here, the ratio of the inner rubber layer 16-1 spring constant to the outer rubber layer 16-2 spring constant is 2:1 or above.

As shown in FIG. 2, the medial plate 18 is perforated by with connecting holes 32 disposed at multiple locations in the circumferential direction, with the inner rubber layer 16-1 and the outer rubber layer 16-2 connecting to one another through these connecting holes 32.

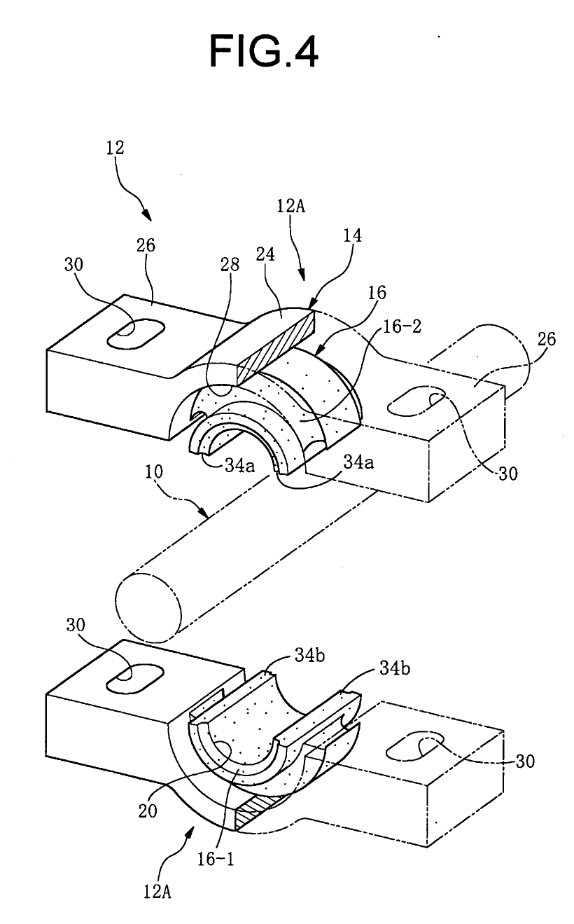

As depicted in FIG. 2 and FIG. 4, the stabilizer bushing 12 of the embodiment is segmented in two circumferential sections at a segmentation plane P that passes through the through-hole 20. The resultant segmented parts 12A, 12A are assembled together, while sandwiching the stabilizer bar 10 therebetween in the axis-perpendicular direction and the rubber elastic body 16 subjected to compressive deformation.

The segmented parts 12A, 12A are constituted so as to divide the stabilizer bushing 12 exactly in half, each having half of the bracket 14, i.e. half of the outer tubular portion 24 and half of the fastening portions 26. Each is furnished with half of the rubber elastic body 16 and half of the medial plate 18 as well.

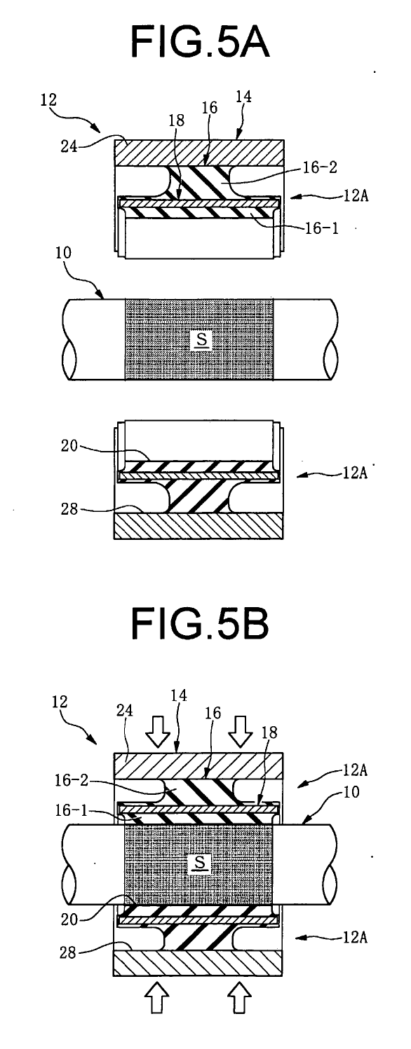

FIGS. 5A and 5B depict the procedure for assembling the segmented parts 12A. First, as depicted in FIG. 5A, segmented parts 12A are obtained by preparatory integral vulcanization molding of the respective halves of the bracket 14, the rubber elastic body 16, and the medial plate 18, and an adhesive S is then preapplied onto the outer circumferential surface of the stabilizer bar 10 over a predetermined axial length thereof (the adhesive S may be applied to the rubber elastic body 16 side or to both this and the stabilizer bar 10).

Then, as depicted in FIG. 5B, the stabilizer bar 10 is sandwiched in the axis-perpendicular direction between a pair of segmented parts 12A, with the segmented brackets 14 of the segmented parts 12A juxtaposed at the segmentation plane P. The brackets 14, 14 are then fastened with clamps or the like to hold the rubber elastic body 16 in a compressed state, and the entire assembly is placed in a hot oven and held for a predetermined length of time, to carry out post-bonding of the rubber elastic body 16, specifically the inner face of the through-hole 20, to the stabilizer bar 10.

The stabilizer bushing 12 is now post-bonded to the stabilizer bar 10 at the inner face of the through-hole 20 in the rubber elastic body 16. Subsequently, with the bolt passed through the fastening hole 30 removed, the bracket is fastened to the vehicle body using the same fastening hole 30. The stabilizer bar 10 is now elastically supported on the vehicle body via the stabilizer bushing 12.

In the embodiment, when the rubber elastic body 16 is compressed by sandwiching the stabilizer bar 10 with the segmented parts 12A, 12A in the axis-perpendicular direction, since the inner rubber layer 16-1 has a high spring constant and the outer rubber layer 16-2 has a low spring constant, axial deformation of the inner rubber layer 16-1 is held to a minimum, flow of the adhesive S in the axial direction in association with excessive deformation of the inner rubber layer 16-1 is reduced satisfactorily, and appreciable necking at the axial ends of the interface of the inner rubber layer 16-1 and the stabilizer bar 10 is prevented.

As a result, concentration of stress at the adhesive interface, especially at the two axial ends of the adhesive interface constituting the necking terminus, can be effectively reduced, and adhesive separation due to the occurrence of cracking in these sections and subsequent propagation of cracks along the adhesive interface, can be effectively prevented. Meanwhile, by means of the medial plate 18 embedded in the medial portion of its cross section, pressure applied to the rubber elastic body 16 in the diameter constricting direction is distributed uniformly over the adhesive interface of the rubber elastic body 16, specifically the inner face of the through-hole 20 of the inner rubber layer 16-1, over the entirety thereof, whereby high adhesive force between the rubber elastic body 16 and the stabilizer bar 10 is achieved.

Additionally, when twisting input is applied to the stabilizer bar 10 during service of the stabilizer bushing 12, it is the outer rubber layer 16-2 that principally undergoes large deformation, with deformation of the inner rubber layer being minimal. This causes a reduction in concentration of stress in the inner rubber layer 16-1, specifically the inner face of the through-hole 20 (adhesive interface), whereby the effects of improved endurance of the stabilizer bushing 12 and enhanced adhesive reliability may be achieved.

Additionally, since no appreciable necking occurs between the stabilizer bar 10 and the stabilizer bushing 12, specifically the inner rubber layer 16-1, the problem of infiltration of muddy water into the area is resolved concomitantly. Also, in this embodiment it is possible to vary the spring constant of the outer rubber layer 16-2 while assuring that sufficient adhesive force is maintained against the stabilizer bar 10 on the inner rubber layer 16-1 side, so that there is the additional advantage of a wider tuning range for the overall spring constant.

Also, in this embodiment, since the bracket 14 for fastening the rubber elastic body 16 to the vehicle body is vulcanization bonded to the rubber elastic body 16, the problem of slippage between the rubber elastic body 16 and the bracket 14, and of abnormal noise produced thereby can be prevented concomitantly.

Additionally, in this embodiment, since half of the fastening holes 30 are formed in the bracket 14 (specifically each half thereof) in the pair of segmented parts 12A, the pair of segmented parts 12A can be tightly fastened with the rubber elastic body 16 compressed therebetween, whereby it is a simple matter to subject the rubber elastic body 16 to the post-bonding process while held in a compressed state.

It should also be appreciated that, as shown in FIG. 2, gaps are formed between circumferential opposite faces 34a, 34b of the segmented parts 12A and 12A at the inner rubber layer 16-1, while the radially inner most part of the inner rubber layer 16-1 extends continuously over the entire circumference of the outer circumferential surface of the stabilizer bar 10 via the adhesive. With this arrangement, elastic deformation of the inner rubber layer 16-1 is effectively absorbed by these gaps, thereby compression force is effectively exerted on a sealing face of the inner rubber layer 16-1, i.e. the inner most part of the inner rubber layer 16-1 continuously extending over the entire circumference of the stabilizer bar 10 via the adhesive S, ensuring enhanced bonding between the inner rubber layer 16-1 and the stabilizer bar 10. Also, gaps formed between the circumferential opposite faces between circumferential opposite faces of the segmented parts 12A and 12A at the outer rubber layer 16-2 can be suitably adjusted to provide required spring characteristics of the stabilizer bushing 12.

While the invention has been described in detail hereinabove in terms of a preferred embodiment, this is merely exemplary, It is also to be understood that the present invention may be embodied with various other changes, modifications and improvements, which may occur to those skilled in the art, without departing from the spirit and scope of the invention defined in the following claims.

What is claimed is:

1. A stabilizer bushing for elastically supporting a stabilizer bar on a vehicle body, comprising:
a tubular rubber elastic body with a through-hole;
a rigid bracket provided with a recess into which the rubber elastic body fits internally, the stabilizer bar being passed through the through hole, and the rubber elastic body being affixed to the vehicle body by the bracket so that the stabilizer bar is elastically supported on the vehicle body; and
a rigid circumferential medial plate embedded in a medial portion of the rubber elastic body in an axis-perpendicular direction so as to extend over substantially an entire axial length of the rubber elastic body with a transverse cross sectional shape curving around the through-hole so that the rubber elastic body is divided by the medial plate into an inner rubber layer situated on an inner peripheral side and an outer rubber layer situated on an outer peripheral side and having a smaller spring constant than the inner rubber layer,
wherein the rubber elastic body, the bracket, and the medial plate are segmented into at least two circumferential segmented parts at a segmentation plane passing through the through-hole, and the bracket and medial plate are integrally vulcanization bonded to the segmented parts during vulcanization molding of the rubber elastic body, and
wherein the integrally vulcanized segmented parts are assembled together sandwiching the stabilizer bar in an axis-perpendicular direction and subjected to compression in the axis-perpendicular direction so that an inside face of the through-hole is subjected to post-bonding to an outer circumferential surface of the stabilizer bar with an adhesive.

2. A stabilizer bushing according to claim 1, wherein the inner rubber layer is thinner than the outer rubber layer.

3. A stabilizer bushing according to claim 1, wherein the outer rubber layer has shorter axial length than the inner rubber layer.

4. A stabilizer bushing according to claim 1, wherein the bracket has holes for fastening to the vehicle body provided in each of the segmented parts at locations to either side of the rubber elastic body in the axis-perpendicular direction.

5. A stabilizer bushing according to claim 1, wherein with the segmented parts being assembled together, a radially inner most part of the inner rubber layer of the rubber elastic body, which constitute the inside face of the through-hole, extends continuously over an entire circumference of the outer circumferential surface of the stabilizer bar via the adhesive, and radially medial and outer parts of the inner rubber layer has circumferential gaps each having a circumferential length gradually increases as it extends radially outwardly, between circumferentially opposite faces of the segmented parts.

6. A stabilizer bushing according to claim 5, wherein the outer rubber layer of the rubber elastic body has circumferential gaps between circumferentially opposite faces of the segmented parts.
